(19) United States
(12) Patent Application Publication
(10) Pub. No.: US 2004/0073557 A1
(43) Pub. Date: Apr. 15, 2004

(54) Method for obtaining information associated with item at specific location

(76) Inventors: Gregory A. Piccionelli, Westlake Village, CA (US); Michael M. Gerardi, Menifee, CA (US)

Correspondence Address: Anna M. Vradenburgh, Brull, Piccionelli, Sarno, Braun & Vradenburgh, Suite 2350, 1925 Century Park East, Los Angeles, CA, 90067, US

(21) Appl. No.: 10/461,170

(22) Filed: Jun. 13, 2003

Related U.S. Application Data
(60) Provisional application No. 60/389,699, filed on Jun. 14, 2002.

(51) Int. Cl. G06F 7/00

(52) U.S. Cl. 707/100

(57) ABSTRACT

A method for obtaining information associated with a target object includes the steps of identifying a target object; determining the location of the target object; providing the location of the target object to a central location; and obtaining from the central location at least one data file pertaining to the target object.

This application is based on U.S. Provisional Patent Application Serial No. 60/389,699, filed Jun. 14, 2002, the disclosure of which is incorporated in its entirety herein by reference.

### FIELD OF THE INVENTION

The present invention relates to a method, system and apparatus for enabling a user to obtain information associated with an item at a specific location.

### BACKGROUND OF THE INVENTION

It is often desirable to obtain information concerning an item of interest to a particular shopper, observer or other individual. For example, a shopper may desire to obtain information concerning pricing, guarantees, warrantees, product safety, recall history, nutritional value, etc., concerning a particular item in a supermarket, shopping center, or other retail establishment. A visitor to an art museum may desire to obtain information concerning the history of an art object on display, the biography of the artist, or the particular school to which the artist may have belonged; visitors to other types of museums, such as natural history museums, may desire to obtain scientific information or additional background information concerning a particular fossil, mineral or artifact.

Recent developments in telecommunications and data processing, and in particular the development of broadband capability in connection with wide-area networks such as the Internet, offer the potential for facilitating the transmission and reception of large amounts of information pertaining to any desired product, art object or any other item. However, at present it is typically necessary to obtain the desired information at a fixed location, such as a home or office computer, an Internet cafe or the like.

A need exists for a method for enabling individuals to obtain information concerning commercial products or other objects at the time the individual visually identifies them.

A need also exists for a system and apparatus for carrying out such a method.

### SUMMARY OF THE PREFERRED EMBODIMENTS

In accordance with one aspect of the present invention, there is provided a method for obtaining information associated with a target object. The method includes the steps of: identifying a target object; determining the location of the target object; providing the location of the target object to a central location; and obtaining from the central location at least one data file pertaining to the target object.

In accordance with another aspect of the present invention, there is provided an apparatus for obtaining information pertaining to a target object. The apparatus includes a ranging device, a GPS location device, wide-area network accessing means, and display means for displaying information provided by a central location via a wide-area network.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flowchart illustrating an example of a method of the invention by which a user identifies, locates and obtains information pertaining to an object of interest, and

FIGS. 2A-C are a schematic diagram, side view and top view, respectively, illustrating an exemplary system for implementing a method of the invention.

Like numerals refer to like parts throughout the several views of the drawings.

### DETAILED DESCRIPTION OF THE PREFERRED EMBODIMENTS

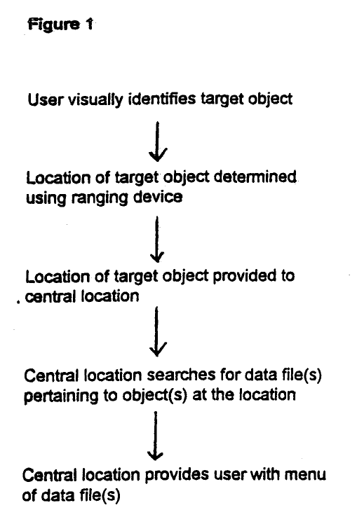

Turning now to the embodiment illustrated in FIG. 1, a user first visually identifies an object of interest (the target object). For example, the user observes a product in a supermarket and desires to obtain information concerning that product.

Next, the user determines the location of the target object, more particularly the location of the target object relative to the user's location. The distance between the user and the target object is determined using a ranging device. Appropriate ranging devices include, without limitation, a device having an element that determines the range to a target based on the eye positions of the user (e.g., using a cross-hairs element); an infrared pointer device; an ultrasonic device; or any other ranging device.

Preferably, the user also carries an element, such as a GPS locator, that provides the user's location, as well as the orientation of the user (i.e., the direction in which the user is facing). The user's location and orientation, together with the location of the target object relative to the user, thus can be used to determine the location of the target object (e.g., its GPS coordinates).

According to a particular embodiment, a user employs a headset including a heads-up display. The user points at an item of interest using at least a portion of a finger or another pointing device. By determining the location of the user's finger or pointing device (for example, by using appropriate ranging means such as those described above), and also the location of the user's point of view, a line can be defined between the two locations. This line can then be extended to intersect the location of the item of interest.

According to more particular embodiments, the line can be extended to intersect other objects or sites having locations at points or within defined areas behind the item of interest (hereafter “collinear objects or sites”).

According to still other particular embodiments, the user can make actual contact with the target object using at least a portion of the user's finger or another pointing device. In such embodiments, the location of the point of contact is considered the location of the target object.

Once the location of the target object has been determined, this location is transmitted to a central location, in particular to a central computer operated by an information service to which the user belongs. In particular embodiments, the information is transmitted via a wide-area network, such as the Internet, using a device carried by the user, such as a personal data manager, a cellular telephone having Internet accessibility, etc.

When the central location is provided with the location of the target object, the central location searches for one or more data files pertaining to an object at that location. Such data files can include, without limitation, text files, photographic files, video files, audio files, and the like. In particular embodiments, the manufacturer, owner, etc., of the object at the identified position provides one or more data files pertaining to the object at that location to the central location.

If the central location identifies one or more data files pertaining to an object at the identified location, the central location provides the user with a positive response, and in particular embodiments provides the user with a menu listing the located data files. The user then selects one or more of the data files to be downloaded and viewed using the user's personal data manager, Internet-equipped cellular telephone or other appropriate device. In more specific embodiments, the user is afforded the option of saving the selected file(s) and/or transmitting the selected file(s) to third parties, for example via e-mail.

According to particular embodiments in which the target object and one or more collinear objects or sites are located, the central location provides the user with a menu of data files pertaining to the target object and/or one or more of the collinear objects and/or sites. The user is then afforded the choice of which object(s) and/or site(s) he desires to investigate further by accessing the data file(s) pertaining thereto.

Embodiments of the foregoing method are also applicable to assist blind or visually-impaired users in identifying objects in their vicinity. In such embodiments, the user extends at least a portion of a finger or other pointing device in a desired direction. The location of the user's fingertip or other pointing device is determined, as is the location of the point of view the user would have (if sighted), and a line is established between the two points, as described above. The line is the extended such that it intersects the location of one or more objects or sites having locations at points along the line. The central site then determines whether one or more data files are associated with one or more objects and/or sites having locations at points along the line, and provides a message to the user, for example an audio message or a data stream that is transmitted to a device implanted in the user or interfacing with the nervous system of the user, offering the user a selection of the data file(s) so located. In this way, the user can identify and access information concerning the nature of adjacent objects and/or sites.

Further embodiments of the inventive method afford identification of target objects even when there is relative motion between the user and the target object. In such embodiments, the location (e.g., the GPS coordinates) of the user and/or the target object, and the distance and direction from the user to the target object, are periodically updated, for example once every millisecond. In specific embodiments, these redeterminations will result in redetermination of lines between the user's point of view and the target object and the identification of new collateral objects and sites.

Additional embodiments of the inventive method can be used for revenue generation and the collection of marketing information. Thus, in certain embodiments, the user is required to provide an exchange of value (e.g., a fee to be charged to a credit account, provision of an e-mail address, agreement to receive e-mail advertising pertaining to the target object, etc.) in order to access the data file(s) pertaining to the target object. In certain other embodiments, the central site maintains a record of each database search for data files pertaining to the target object. Such records can provide marketing researchers with a measure of consumer interest in the target objects.

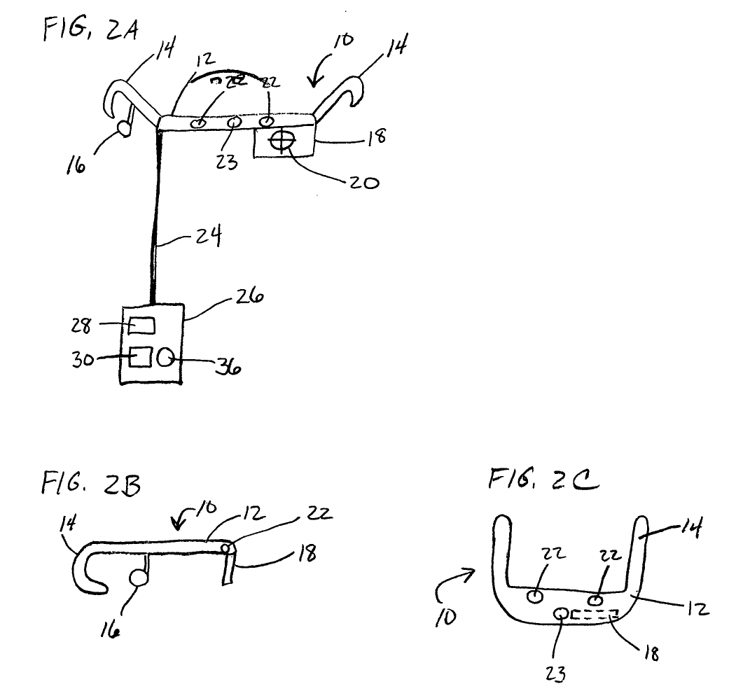

An embodiment of an apparatus useful in practicing methods according to the present invention is illustrated in FIGS. 2A-C. The apparatus includes an ocular ranging device, in particular a cross-hairs element and an element that measures the positions of the inquiring individual's eyes and uses these measurements to determine the distance to the target, or to the user's finger or other pointing device (e.g., by triangulation); an integrated data processing and transceiving unit that includes (a) a GPS location device; (b) a wide-area network accessing element including (1) a processor provided with appropriate software and (2) a modem; and (c) a display element, in particular including an HUD, and also preferably including an earphone or other element for providing audio information. The ranging element, the HUD and the earphone can be part of a headset which is in turn connected to the wide-area network accessing element.

Referring to FIGS. 2A-C, an embodiment of a system for implementing a method of the invention includes a headset 10 having a frame 12 and ear pieces 14. Affixed to frame 12 are earphone 16, HUD 18 having a cross-hairs element 20, sensors 22 for determining the positions of the eyes of a user wearing the headset 10, and direction determining element 23 (such as an electronic compass). Earphone 16, HUD 18, sensors 22 and direction determination element 23 are in electrical communication via cord 24 with integrated processing/transceiving unit 26, which preferably is carried or worn by the user. Unit 26 includes a GPS location determination element 28 (in particular embodiments in electrical communication with HUD 18 to enable display of GPS coordinates on the HUD), a processing element 30, preferably including a microprocessor and appropriate software and preferably in electrical communication with HUD 18 to enable display of data files and other information, and optionally a trackball 36 for positioning a cursor (not shown) displayed on HUD 18 to enable the inquiring individual to select one or more menu items viewed on the HUD.

Additional security can be provided, in very particular embodiments, through use of pattern recognition means in combination with an apparatus as described above. A user's finger, in particular embodiments, is recognized by pattern recognition means, such as a microchip programmed with pattern recognition software and incorporated into the apparatus together with a digital camera or other appropriate video input device. If an unauthorized user attempts to utilize the apparatus and uses a finger for ranging purposes as described herein, the pattern recognition means will determine that the user is unauthorized. In such an event, the operation of the apparatus is modified. For example, the apparatus is disabled in response to an appropriate signal generated by the pattern recognition means. Alternatively, a signal is provided to the central location alerting the central location that an unauthorized user is in possession of the apparatus.

What is claimed is:

1. A method for obtaining information associated with a target object, the method comprising the steps of:
a) identifying a target object,
b) determining the location of the target object,
c) providing the location of the target object to a central location, and
d) obtaining from the central location at least one data file pertaining to the target object.

2. The method of claim 1 wherein in step b) the location of the target object is determined using a ranging device.

3. The method of claim 2 wherein the location of the target object is determined relative to the location of a user visually identifying the target object.

4. The method of claim 3 wherein the location of the target object is determined based on the GPS coordinates of the user and the distance and direction from the user to the target object.

5. The method of claim 1 wherein in step c) the central location is a central computer operated by an information service to which a user visually identifying the target belongs.

6. The method of claim 5 wherein the location is provided to the central location via a wide-area network.

7. The method of claim 6 wherein the location is provided to the central location by means of a device carried by the user.

8. The method of claim 1 wherein in step d) the central location searches a data base for at least one data file pertaining to the target object.

9. The method of claim 1 wherein the central location tracks the number of times a data base is searched for at least one data file pertaining to the target object.

10. A method for obtaining information pertaining to a target object, the method comprising the steps of:
a) identifying a target location identifier,
b) associating the target location identifier with at least one data file,
c) providing the target location identifier to a central location, and
d) obtaining from the central location at least one data file pertaining to the target location identifier.

11. The method of claim 10 wherein the target location identifier is selected from the group consisting of a GPS coordinate and a point in a virtual space.

12. The method of claim 10 wherein a plurality of target location identifiers are associated with one data file.

13. The method of claim 12 wherein a plurality of data files are associated with one target location identifier.
